(19) United States
(12) Patent Application Publication
(10) Pub. No.: US 2009/0254406 A1
(43) Pub. Date: Oct. 8, 2009

(54) WORKSPACE VISUALIZATION

(76) Inventors: Johannes Von Sichart, San Jose, CA (US); Ruben Rohde, Alameda, CA (US)

Correspondence Address: BRINKS HOFER GILSON & LIONE, P.O. BOX 10395, CHICAGO, IL, 60610, US

(21) Appl. No.: 12/099,667

(22) Filed: Apr. 8, 2008

(51) Int. Cl. G06F 3/14; G06Q 10/00

(52) U.S. Cl. 705/9; 715/273

(57) ABSTRACT

A system for visually representing one or more projects in a workspace is provided. The system includes a display; and a processor operable to identify one or more project characteristics and determine a hierarchy of the one or more projects as a function of the one or more project characteristics. The processor being operable to visually represent the one or more projects as an interactive representation on the display as a function of the hierarchy.

### BACKGROUND

The present embodiments relate to workspace visualization.

A workspace is used to manage one or more work projects. The workspace includes visual representations of the one or more work projects. The visual representations may include representations of project labels, tasks, links, documents, communication, pathways, or any related information.

The type of visual representation of the one or more projects is the same. For example, the visual area representing a first project is the same shape, size, opacity, and/or shading as a visual area representing a second project. Although the information included in the one or more visual representations may be different, the visual attributes of the area representing the project are the same.

### BRIEF DESCRIPTION OF THE DRAWINGS

FIG. 1 illustrates one embodiment of a system for visually representing one or more projects.

FIGS. 2-6 illustrate different embodiments of a workspace.

FIG. 7 illustrates one embodiment of a flowchart for visually representing one or more projects in a workspace.

### DETAILED DESCRIPTION

The present embodiments relate to visually representing one or more work projects as functions of one or more project characteristics. Different projects of a company, division, or work group are visually depicted on a single screen. The visual depictions are adjusted based on project activity or importance. For example, if a project is important, its visual representation may be larger than other project visual representations. In another example, the shading of a visual representation may be varied based on project activity. Other project indications may be used to differentiate between the projects. For example, an active project that is almost complete may be very bright while an inactive project can be depicted as fading away. Visual characteristics, such as color, opacity, and/or size, are used to communicate project type, importance/relevance, and project status. The visual characteristics are non-textual and/or non-order based, such as characteristic in addition to or as alternatives to a textual or order indication. The visual representations are displayed differently based on various inputs.

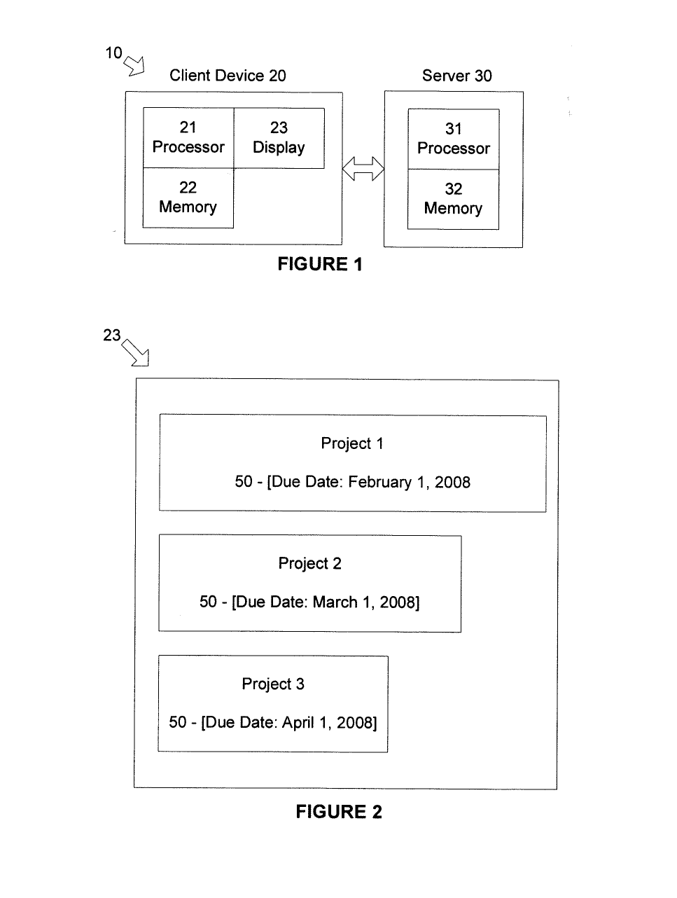

FIG. 1 shows a system 10 for visually representing one or more projects. The system 10 may include a client device 20 and server 30. Additional, different, or fewer components may be provided. For example, the system 10 may include a plurality of client devices 20 and/or servers 30. In another example, the system 10 may not have a server 30. Processing may be computed locally, for example, by the client device 20.

The system 10 is a network, web-system, intranet system, Internet system, portal system, remote terminal system, communication system, or any combination thereof. For example, the system 10 is a business network providing automated project management. The system 10 may automatically organize visual representations of projects on a workspace according to importance of the project. In another example, the system 10 is a portal system that visually distinguishes a first visual representation of a first project from a second visual representation of a second project. The first and second visual representations are visualized at a portal or as part of a display associated with a portal.

The client device 20 may include a processor 21, memory 22, and display 23. Additional, different, or fewer components may be provided. For example, the client device 20 may include an input device for inputting information to the system 10. The client device 20 is a workstation, personal computer, remote terminal, endpoint, web browser, handheld device, cellular phone, or other now known or later developed device for displaying a workspace. The client device 20 may communicate with the server 30 using a protocol, such as an Internet Protocol (IP), Transmission Control Protocol (TCP), or other now known or later developed protocol.

The processor 21 may receive information from and/or transmit information to the server 30. For example, the processor 21 may receive workspace data from the server 30. The processor 21 may use workspace data to cause a workspace to be displayed on the display device 23. The displayed workspace has visual representations of one or more projects.

The processor 21 may transmit information to the server 30. Transmitted information may be used to update a workspace database stored in the memory 32. For example, the client device 20 may transmit task completion data to the server 30. The task completion data may represent the completion of a task, for example, by a user. The task completion data may be used to update the workspace data being transmitted to the client device 20, as discussed below. The task completion data may be used to remove one or more visual representations from the workspace. For example, a visual representation of a project may be removed or a visual representation of a task to be completed may be removed. Other data may be transmitted from the client device 20 to the server 30, such as documents, document locations, or other project related information. The data may be stored in the workspace database and used to generate, update, or configure workspace data.

The display device 23 is a CRT, monitor, flat panel, a general display, LCD, projector, printer or other now known or later developed display device for outputting information. The display device 23 may display one or more images. For example, the display device 23 may display images, projections, or representations of a workspace. In another example, the display device 23 may display 3D images, projections, or representations.

The display device 23 may display a workspace. A workspace is a user-interface, interactive interface, graphical user interface (GUI), collaborative team room, shared space, portal, teamspace, HTML web page, Internet page, intranet page, homepage, or other project management interface that displays one or more projects. A processor, such as processor 21 or 31, may process workspace data and cause a workspace to be displayed on the display device 23. A workspace is organized information shown on the display device 23. The workspace may be used to work, communicate, search, navigate, view information, or perform other tasks.

As shown in FIG. 2, a workspace may include visual representations of one or more projects to be completed. Additional, different, or fewer representations may be provided. For example, searches, clocks, links, and/or other information may be provided. The visual representations may be interactive. For example, a user may perform a task associated with the visual representations. The workspace may provide assistance for managing projects. For example, the workspace may organize the visual representations according to importance of a project. The importance of a project may be based on the level of priority assigned to the project, due dates, number tasks yet to be completed, number of tasks completed, or other criteria for determining the importance of a project.

In one embodiment, the workspace is a portal. The portal is a site, which the owner positions as an entrance to other sites on the Internet, Intranet, or other network. The portal presents information from diverse sources in a unified way. The portals may be used to access information from other locations for the projects. For example, the portal may include a visual representation of a document. When a portal user clicks on the document logo, the portal user may access the document stored at a specific location.

The portal may be a web portal, personal portal, or enterprise portal. A web portal provides a function via a web page or site. A web portal may function as a point of access to information. Aside from the search engine standard, web portals may offer other services such as e-mail, news, stock prices, entertainment, and various other applications. Portals provide a way for enterprises to provide a consistent look and feel with access control and procedures for multiple applications, which otherwise would have been different entities altogether.

A personal portal may provide personalized capabilities, providing a pathway to other content. It is designed to use distributed applications, different numbers and types of middleware and hardware to provide services from a number of different sources. A personal portal may be customized according to the user's preferences.

An enterprise portal is a framework for integrating information, people and processes across organizational boundaries. The enterprise portal may be referred to as an enterprise information portal (EIP) or business portal. Enterprise portals are designed to share collaboration in businesses, workplaces, divisions, or groups. An enterprise portal provides a secure unified access point, often in the form of a web-based user interface, and is designed to aggregate and personalize information through application-specific portlets. For example, an enterprise portal may include project application windows, calendars and to-do lists, discussion groups, announcements and reports, searches, email and address books, project documents, search engines, news, weather, maps, and shopping, bookmarks.

The server 30 may include a processor 31 and memory 32. Additional, different, or fewer components may be provided. For example, the server 30 may include a display device and/or input device. The server 30 is a business server, application server, centralized processing server, remote terminal server, WEB server, Internet server, intranet server, workstation, personal computer, database server, or other now know or later developed server. The server 30 may be a repository and distributor of information. The server 30 may communicate with the client device 20 or other communication device, such as a web server.

The processors 21 and 31 are general processors, digital signal processors, application specific integrated circuits, field programmable gate arrays, analog circuits, digital circuits, combinations thereof, or other now known or later developed processors. The processors 21 and 31 may be single devices or a combination of devices, such as associated with a network or distributed processing. Any of various processing strategies may be used, such as multi-processing, multi-tasking, parallel processing, or the like. Processing may be local, as opposed to remotely. For example, the processor 21 is operable to perform processing completed by the processor 31. The processors 21 and 31 are responsive to instructions stored as part of software, hardware, integrated circuits, firmware, micro-code or the like.

The processor 31 may generate workspace data. Generation of workspace data may include retrieving, receiving, combining, determining, or calculating data. For example, the processor 31 may retrieve or receive all, some, or none of the workspace data from memory 32 or other communication devices, such as other servers 30 or client devices 20. In another example, the processor 31 may retrieve workspace data from a WEB server.

Workspace data is used to generate and display a workspace. For example, the processor 21 may receive the workspace data from the server 30 and cause the workspace to be displayed on the display device 23.

The workspace data may include data relating to a project, such as project characteristics and/or visual representation data. A project may be a planned undertaking with a specific goal or aim. A project may be a task, a series of tasks, or a problem. One or more workers, students, people, or machines may engage in or be assigned to working on a project. A project may have a defined goal, such as finishing tasks X, Y, and Z. Alternatively, a project may be ongoing, such as researching or developing.

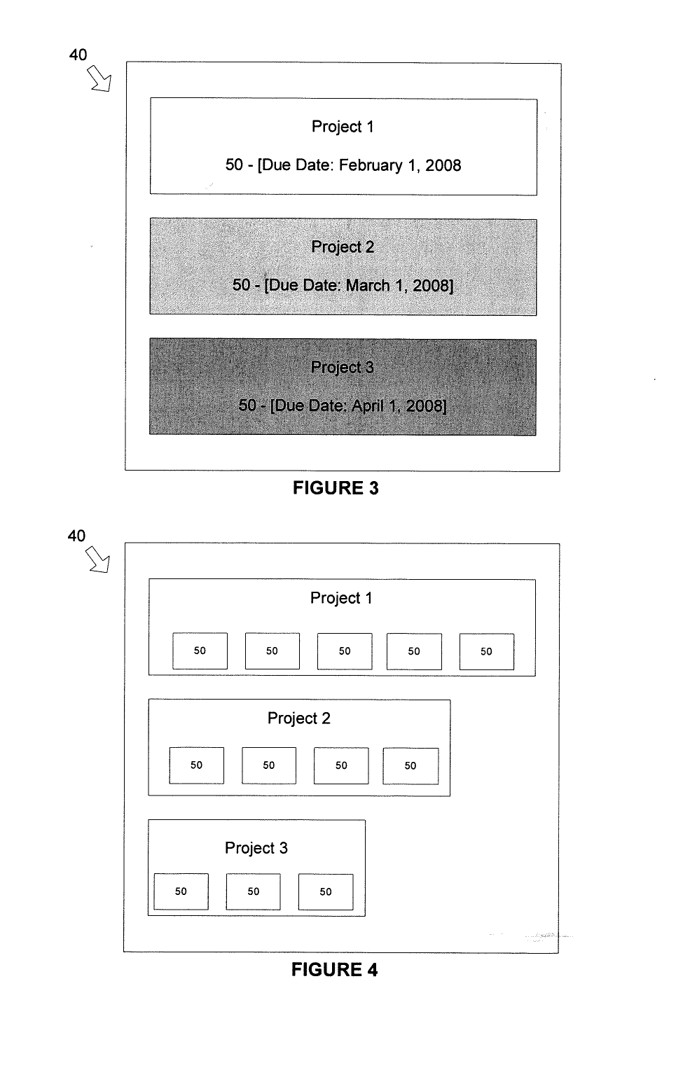

The processor 31 may identify project characteristics 50 that are related to the project. Project characteristics 50 may include tasks to be completed, tasks completed, numbers of tasks completed or to be completed, due date(s), project activity, project status, project importance, priority level, group member(s), project name, goals, or other any characteristics related to the project. Project characteristics may be attributes of the project, such as a distinguishing trait, quality, priority, or property. For example, as shown in FIG. 2, Project 1 may have a due date of Feb. 1, 2008. The due date is a project characteristic 50. In another example, as shown in FIG. 3, there are four tasks to be completed in Project 2. The number of tasks to be completed (e.g., four) is a project characteristic 50. In another example, a project may include a “high priority” value of a project characteristic and another project may include a “low priority” value of the project characteristic. A given project may have one or more different types of characteristics, such as a priority, number of tasks, and due date.

The workspace data may include project characteristic data. The project characteristic data may be used to display one or more project characteristics or define visual representations of the workspace. For example, workspace data may include a list of tasks to be completed. The list of the tasks to be completed may be displayed on the workspace. A project characteristic may be the number of items in the list. In another example, the project characteristic data may be used to adjust, change, alter, or replace all, some, or none of visual representation data.

The workspace data may include visual representation data. The visual representation data may be used to display visual representations of the workspace, such as visual representations of one or more projects. The visual representations may be displayed as text, graphics, shapes, windows or other visual areas. For example, each project is assigned a specific or unique visual area. As shown in the example of FIG. 2, “Project 1,” “Project 2,” and “Project 3” may be represented by separate visual areas, which are rectangular in shape. The visual representation may be any shape, such as a circle, star, or other now known or later developed shaped. Overlapping or non-unique spacing may be used.

The visual representations of the one or more projects may include interactive representations. For example, a visual representation of a project may include visual representations of project information (e.g., project characteristics), pathways to other project related information, project related tasks, and/or other project related information (e.g., documents). The visual representation of a project is a portal, so may provide pathways to information, documents, communications, or other relevant project information. The visual representation is a visualization of a project. Visualization is any technique for creating images, diagrams, or animations to represent a project. The visual representation may or may not be a textual representation. For example, an image or diagram may be used to represent the project. The visualization may be associated with a pathway to project information, such as a project website or network location. In another example, documents, websites, conversations, communication, or other relevant project information may be visually represented. The visualization of documents may be associated with a pathway to a memory location where the document is being stored, so the visualization may be used to access the document. Alternatively, a web page may be visually represented. The visual representation may include a link to the web page.

The processor 31 may graphically define the visual representation of a project. The visual representation may be defined as a function of one or more project characteristics 50. The processor 31 may adjust one, some, none, or all of the visual representations of the one or more projects. Adjustment may be based on project characteristics associated with each project. For example, the spatial size, opacity, color, brightness, fading, boldness, or other visual characteristics may be defined by one or more project characteristics 50.

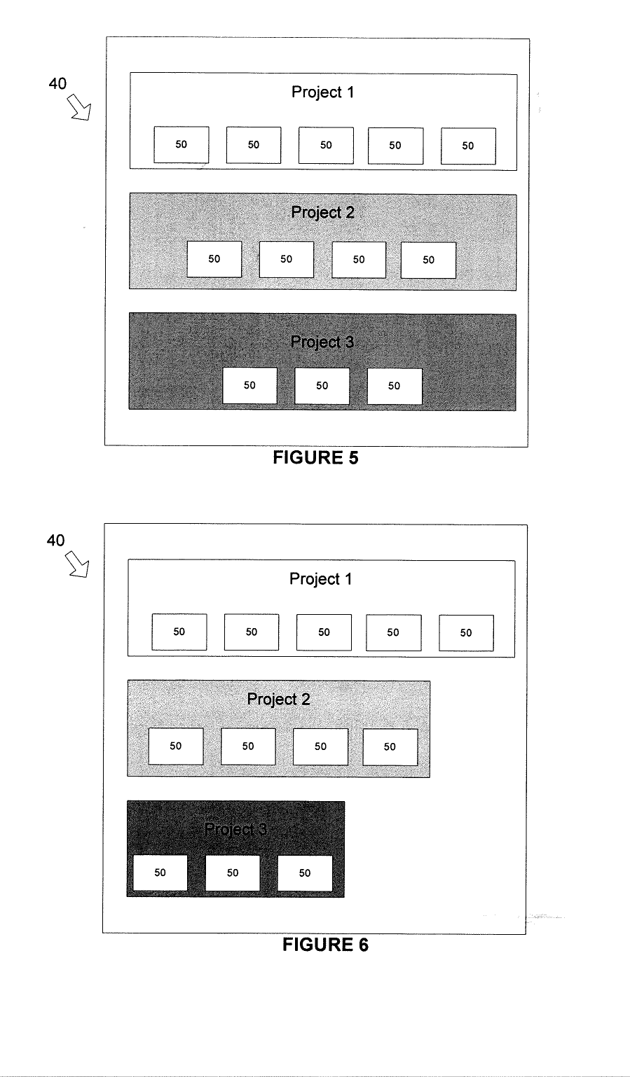

The processor 31 may compare a project characteristic 50 of a first project to a project characteristic 50 of one or more other projects. Comparison may include calculation. For example, the processor 31 determine a hierarchy of projects based on importance or project activity, calculate a due date, compare a due date to another due date, determine the number of tasks to be completed, compare a list of tasks with another list of tasks, read a database to determine a project status, or retrieve relevant information for calculation. Comparison may be used to define the visual representation of the first project. For example, the comparison may be used to organize, manage, adjust, or change one or more visual representation. The visual representations of each project may be defined according to one or more project characteristics of one, some, or all of the projects displayed in the workspace. For example, as shown in FIGS. 2-6, the project characteristics 50 of other projects may define the visual representations of each of the projects (Project 1, 2, and 3) relative to each other or based on comparison with standards or thresholds.

As shown in FIG. 2, the spatial sizes of the visual representations of Project 1, Project 2, and Project 3 may be graphically defined as functions of the project characteristic 50, which in FIG. 2 are the due dates for each project. For example, Project 1 has a due date that is before the due dates of Project 2 and Project 3. Accordingly, the spatial size of the visual representation of Project 1 is larger than the visual representations of Project 2 and Project 3. Project 2 has a due date that is before the due date of Project 3, so the spatial size of the visual representation of Project 2 is larger than the spatial size of the visual representation of Project 3. Accordingly, a user may view the workspace, which includes the visual representations of Projects 1, 2, and 3, and identify that Project 1 has a due date before Project 2 and Project 3 without reference to undisplayed information or displayed text. In another example, the spatial size of Project 1, which has a due date before Project 2 and Project 3, may be smaller than the spatial size of the visual representations of Project 2 and Project 3. Two or more projects may be represented with a same size representation where the due dates are the same or without a range of time of each other or a threshold.

As shown in FIG. 3, the opacity of the visual representations of Project 1, Project 2, and Project 3 may be defined as functions of the project characteristic 50, which in this case are the dates that each project is due. For example, as discussed above with respect to FIG. 2, Project 1 has a due date that is before the due dates of Project 2 and Project 3. Accordingly, the opacity of the visual representation of Project 1 is less than the opacity of the visual representations of Project 2 and Project 3. For example, the visual representation of Project 1 is lighter than the visual representations of Project 2 and Project 3. Project 2 has a due date that is before the due date of Project 3, so the opacity of the visual representation of Project 2 is less than the opacity of the visual representation of Project 3. Accordingly, a user may view the workspace, which includes the visual representations of Projects 1, 2, and 3, and identify that Project 1 has a due date before Project 2 and Project 3. In another example, the spatial size of Project 1, which has a due date before Project 2 and Project 3, may be smaller than the spatial size of the visual representations of Project 2 and Project 3.

The processor 31 may compare other project characteristics 50. For example, as shown in FIGS. 4-6, the processor 31 may compare the number of tasks to be completed. As shown in FIGS. 4-6, Project 1 has five tasks to be completed (a project characteristic 50). Project 2 has four tasks to be completed and Project 3 has three tasks to be completed. As shown in FIG. 4, since Project 1 has a greater number of tasks to be completed than Project 2 or Project 3, the spatial size of the visual representation of Project 1 may be spatially larger than the visual representation of Project 2 and Project 3. Likewise, since Project 2 has a greater number of tasks to be completed than Project 3, the spatial size of the visual representation may be spatially larger than the visual representation of Project 2 and Project 3. As shown in FIG. 4, since Project 1 has a greater number of tasks to be completed than Project 2 or Project 3, the opacity of the visual representation of Project 1 may be less (e.g., lighter) than the visual representation of Project 2 and Project 3. Likewise, since Project 2 has a greater number of tasks to be completed than Project 3, the opacity of the visual representation of Project 1 may be spatially larger than the visual representation of Project 2 and Project 3.

As shown in FIG. 6, two or more graphical features of a visual representation of a project may be defined as a function of one or more project characteristics 50. For example, the spatial size and opacity of the visual representations of Projects 1, 2, and 3 are defined by due date and number of tasks to be competed, respectively.

The processor 31 may communicate with the memory 32. The processor 31 may transmit information to and/or receive information from the memory 32. For example, the processor 31 may retrieve a workspace database stored in the memory 32. For example, the processor 31 may transmit workspace data to the memory 32. In another example, the processor 31 may retrieve workspace data from the memory 32 and update the retrieved workspace data

The memory 32 is a computer readable storage media. The computer readable storage media may include various types of volatile and non-volatile storage media, including but not limited to random access memory, read-only memory, programmable read-only memory, electrically programmable read-only memory, electrically erasable read-only memory, flash memory, magnetic tape or disk, optical media and the like. The memory 32 may be a single device or a combination of devices. The memory 32 may be adjacent to, part of, networked with and/or remote from the processor 31.

The memory 32 may be a computer readable storage media having stored therein data representing instructions executable by the programmed processor 31 for visually representing a project in a workspace. The memory 32 stores instructions for the processor 31. The processor 31 is programmed with and executes the instructions. The functions, acts, methods or tasks illustrated in the figures or described herein are performed by the programmed processor 31 executing the instructions stored in the memory 32. The functions, acts, methods or tasks are independent of the particular type of instructions set, storage media, processor or processing strategy and may be performed by software, hardware, integrated circuits, firm ware, micro-code and the like, operating alone or in combination. The instructions are for implementing the processes, techniques, methods, or acts described herein.

The computer readable storage media stores data representing instructions executable by a programmed processor, such as the processors 21 or 31, for visually representing one or more projects in a workspace. The instructions may include identifying one or more project characteristics 50 for one or more projects, and visually representing the one or more projects as an interactive representation that is graphically defined by the one or more project characteristics.

The memory 32 may store a workspace database. The workspace database may include workspace data and/or other information relating to visual representations of one or more projects, such as project characteristics 50. The workspace database may be organized, for example, according to users associated with the workspace. The workspace database may be accessed to retrieve information about a workspace. For example, a user, such as John Doe, may request information relating to a workspace associated to him. The workspace may include workspace data that visually represents projects in which John Doe is involved.

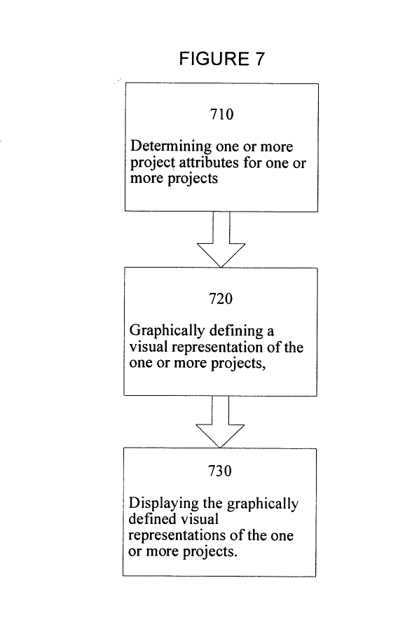

FIG. 7 shows a method for visually representing one or more projects in a workspace. The method is implemented using the system 10 of FIG. 1 or a different system. The acts may be performed in the order shown or a different order. For example, act 730 does not need to be performed. The acts may be performed automatically, manually, or the combination thereof.

The method for visually representing one or more projects may include determining one or more project characteristics for one or more projects (act 710), graphically defining a visual representation of the one or more projects (act 720), and displaying the graphically defined visual representations of the one or more projects (act 730). Additional, different, or fewer acts than shown in FIG. 6 may be provided. For example, the method may include transmitting the data defining the visual representation of the one or more projects.

In act 710, one or more project characteristics for one or more projects are determined. Determining a project characteristic may include retrieving the project characteristic, calculating the project characteristic, receiving the project characteristic, or any combination thereof. Additional or different methods may be used for determining the one or more project characteristics.

A project characteristic may be retrieved from memory. A processor may retrieve the project characteristic from memory. For example, project characteristic data may be stored in a workspace database, which is stored in computer readable memory. The project characteristic may be retrieved from the workspace database. Additional information may be retrieved from the workspace database, such as information associated with the project or project characteristic. The information associated with the project or project characteristic may be used to calculate the project characteristic. In the example of FIG. 4, a processor may retrieve information associated with the project, such as a list of the tasks that have not been completed.

A project characteristic may be automatically calculated. The project characteristic may be automatically calculated as a function of data retrieved from memory, received from a communication device, or manually input. For example, a processor may automatically calculate a project characteristic using information associated with the project or project characteristic. In the example of FIG. 4, the processor may automatically calculate a value for a project characteristic, such as three tasks to be completed for Project 3, by counting the number of tasks in the list of tasks that have not been completed. In another example, the project characteristic may be automatically calculated using information retrieved from memory and information received from a communication device, such as task completion data.

A project characteristic may be received from a communication device. For example, a project characteristic may be received from an input device or other communication device. The project characteristic may be manually input.

A project characteristic may be determined for one or more projects. The project characteristic for one project may be different than a project characteristic for another project. For example, the due date for one project may be different than the due date for another project. In another example, the level of priority for one project may be different than the due date for another project. The project characteristics for each project are determined.

In act 720, a visual representation of one or more projects may be graphically defined as a function of the one or more project characteristics. Graphically defining the visual representations of the one or more projects may include comparing project characteristics of the one or more projects and adjusting the visual representation data to represent the graphical definition. The adjustment may be of a characteristic other than text displayed as part of the visual representation. A title, list of tasks, due date, assigned team members, notes, or other project information is provided textually. A non-textual aspect of the visualization is adjusted, such as adjusting a size of the text, a color of the text, a size of a border, a color of a border, color of fill, shape of a border, texture, pattern or other aspect. Additional, different, or fewer acts may be provided for graphically defining the one or more projects.

Project characteristics of the one or more projects may be compared. Project characteristics may be compared automatically, manually, or a combination thereof. For example, a processor may automatically compare project characteristics between projects. The comparison may be a calculation, such as determining which project is greater or closer. In the example of FIG. 2, the due date of one of the projects may be compared to the due dates of the other projects. The comparison may alternatively be with a threshold or thresholds, such as defining ranges of numbers of tasks to be completed.

The visual representation data may be adjusted for each visual representation to reflect the graphical definition. The visual representation data may be used to display a visual representation of one or more projects. The visual representation data may be adjusted to reflect the comparison of project characteristics. For example, the visual representation data may be adjusted to visually distinguish based on the comparison. The visual representation data reflects the differences or similarities identified during the comparison. The visual representation data may be adjusted to reflect a sizing change of the visual representations. The visual representation data may be adjusted to reflect an opacity change of the visual representations.

The visual representation data may be adjusted to visually distinguish between one or more projects when displayed. For example, the visual representation data is adjusted to reflect a characteristic of the project, such as project activity or project importance.

In act 730, the visual representations of the one or more projects may be displayed. Displaying the visual representations of the one or more projects may include transmitting visual representation data, processing visual representation data, and causing the visual representations of the one or more projects to be displayed on a display device or monitor. Additional, different, or fewer acts may be performed. For example, the visual representation data may not be transmitted. In another example, the visual representation data may be stored for later use.

The visual representation data may be transmitted. The visual representation data may be transmitted from a first server to a client device or other communications device, such as a second server. The visual representation data may be transmitted using any now known or later developed transmission techniques, such as a wireless connection or cable-based connection.

The visual representation data may be processed. A client device may process the visual representation data and cause a visual representation of one or more projects to be displayed on a display device or monitor based on the processed data. The visual representation data may be processed with or combined with other data relating to a workspace.

Various embodiments described herein can be used alone or in combination with one another. The forgoing detailed description has described only a few of the many possible implementations of the present invention. For this reason, this detailed description is intended by way of illustration, and not by way of limitation. It is only the following claims, including all equivalents that are intended to define the scope of this invention.

1. A method for visually representing one or more projects in a workspace, the method comprising:
identifying one or more project characteristics for the one or more projects,
displaying the workspace indicating the one or more projects, and
visually representing the one or more projects each as a visual representation, each visual representation graphically defined by the one or more project characteristics, the graphically defined aspect of the visual representation being other than text.

2. The method as claimed in claim 1, wherein identifying a project characteristic includes identifying a due date.

3. The method as claimed in claim 1, wherein identifying a project characteristic includes identifying a number of tasks to be completed.

4. The method as claimed in claim 3, wherein identifying a project characteristic includes comparing the number of tasks associated with one of the projects to a number of tasks of another projects.

5. The method as claimed in claim 4, wherein a first project having a number of tasks is visually represented by a different visual representation than a second project having a smaller number of tasks.

6. The method as claimed in claim 1, comprising ranking the one or more projects based on the project characteristics for the one or more projects.

7. The method as claimed in claim 1, wherein visually representing the one or more projects includes sizing the one or more project representation based on the one or more project characteristics.

8. The method as claimed in claim 1, wherein visually representing the one or more projects includes changing the brightness or shading of the visual representation of the one or more projects based on the one or more project characteristics.

9. The method as claimed in claim 1, wherein visually representing the one or projects includes visually distinguishing the one or more projects based on the one or more project characteristics.

10. A system for visually representing one or more work projects in a workspace, the system comprising:
a processor operable to identify one or more project characteristics of each of a plurality of work projects, and determine a hierarchy of the plurality of work projects as a function of the one or more project characteristics, and
a display operable to visually represent the plurality of work projects each as a visual representation, each visual representation having a non-textual and non-order characteristic that is a function of the hierarchy.

11. The system as claimed in claim 10, wherein the one or more project characteristics may include project due dates.

12. The system as claimed in claim 11, wherein the hierarchy of the one or more projects ranks the one or more projects according to project due dates.

13. The system as claimed in claim 10, wherein the one or more project characteristics may include one or more tasks to be completed.

14. The system as claimed in claim 13, wherein the hierarchy of the one or more projects ranks the one or more projects as a function of a number of tasks to be completed for the one or more projects.

15. The system as claimed in claim 13, wherein a size of the visual representation of the one or more projects may be determined as a function of the hierarchy.

16. The system as claimed in claim 13, wherein a shading of the visual representation of the one or more projects may be determined as a function of the hierarchy.

17. The system as claimed in claim 13, wherein a brightness of the visual representation of the one or more projects may be determined as a function of the hierarchy.

18. A method for visually representing projects in a workspace, the method comprising:
identifying one or more project characteristics for each of a plurality of projects, and
presenting, in a computer generated workspace, a portal to a plurality of projects, each of the plurality of projects having a border, color, fill, size, or combination thereof being a function of the one or more project characteristics.

19. The method as claimed in claim 18, wherein a first of the plurality of projects has a different border, color, fill, size, or combination thereof as a second of the plurality of projects.

20. The method as claimed in claim 1, wherein one or more project characteristics of the first of the plurality of projects is compared to the second of the plurality of projects.
